(19) United States
(12) Patent Application Publication
(10) Pub. No.: US 2007/0101102 A1
(43) Pub. Date: May 3, 2007

(54) Selectively pausing a software thread

(76) Inventors: Herman Dietrich Dierks JR., Round Rock, TX (US); Jeffrey Paul Messing, Austin, TX (US); Rakesh Sharma, Austin, TX (US); Satya Prakash Sharma, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/260,612

(22) Filed: Oct. 27, 2005

(51) Int. Cl. G06F 9/30

(52) U.S. Cl. 712/214

(57) ABSTRACT

A method, system and computer-usable medium are presented for pausing a software thread in a process. An instruction from a first software thread in the process is sent to an Instruction Sequencing Unit (ISU) in a processing unit. The instruction from the first software thread is then sent to a first instruction holding latch from a plurality of instruction holding latches in the ISU. The first instruction holding latch, which contains the instruction from the first software thread, is then selectively frozen, such that the instruction from the first software thread is unable to pass to an execution unit in a processor core while the first instruction holding latch is frozen. This causes the entire first software thread to likewise be frozen, while allowing other software threads in the process to continue executing.

### BACKGROUND OF THE INVENTION

1. Technical Field

The present invention is related to the field of computers, and particularly to computers capable of simultaneously executing multiple software threads. Still more particularly, the present invention is related to a system and method for pausing a software thread without the use of a call to an operating system's kernel.

2. Description of the Related Art

Many modem computer systems are capable of multiprocessing software. Each computer program contains multiple sub-units known as processes. Each process is made up of multiple threads. Each thread is capable of being executed, to a degree, autonomously from other threads in the process. That is, each thread is capable of being executed as if it were a “mini-process,” which can call on a computer's operation system (OS) to execute on its own.

During the execution of a first thread, that thread must often wait for some asynchronous event to occur before the first thread can complete execution. Such asynchronous events include receiving data (including data that is the output of another thread in the same or different process), an interrupt, or an exception.

An interrupt is an asynchronous interruption event that is not associated with the instruction that is executing when the interrupt occurs. That is, the interruption is often caused by some event outside the processor, such as an input from an input/output (I/O) device, a call for an operation from another processor, etc. Other interrupts may be caused internally, for example, by the expiration of a timer that controls task switching.

An exception is a synchronous event that arises directly from the execution of the instruction that is executing when the exception occurs. That is, an exception is an event from within the processor, such as an arithmetic overflow, a timed maintenance check, an internal performance monitor, an on-board workload manager, etc. Typically, exceptions are far more frequent than interrupts.

Currently, when an asynchronous event occurs, the thread calls the computer's OS to initiate a wait/resume routine. However, large numbers of instructions in the OS are required to implement this capability, since the OS must implement a system call and a process/thread dispatch. The operations carry a heavy overhead in time and bandwidth to the computer, thus slowing down the execution of the process, slowing down the overall performance of the computer, and creating a longer latency among thread executions.

### SUMMARY OF THE INVENTION

In recognition of the above-stated problem in the prior art, a method, system and computer-usable medium is presented for pausing a software thread in a process. An instruction from a first software thread in the process is sent to an Instruction Sequencing Unit (ISU) in a processing unit. The instruction from the first software thread is then sent to a first instruction holding latch from a plurality of instruction holding latches in the ISU. The first instruction holding latch, which contains the instruction from the first software thread, is then selectively frozen, such that the instruction from the first software thread is unable to pass to an execution unit in a processor core while the first instruction holding latch is frozen. This causes the entire first software thread to likewise be frozen, while allowing other software threads in the process to continue executing. Thus, a software thread can be paused without (i.e., independently of) the use of a call to an operating system's kernel.

The above, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1a is a high-level illustration of a flow of a process' instructions moving through an Instruction Holding Latch (IHL), an Execution Unit (EU), and an output;

FIG. 1b depicts a block diagram of an exemplary processing unit in which a software thread may be paused/frozen;

FIG. 1c illustrates additional detail of the processing unit shown in FIG. 1b

FIG. 2 depicts additional detail of supervisor level registers shown in FIG. 1c

FIG. 3 is a flow-chart of exemplary steps taken to pause/freeze a software thread;

FIG. 4 illustrates exemplary hardware used to freeze a clock signal going to an IHL and EU; and

FIG. 5 depicts a high-level view of software used to pause/freeze a software thread.

### DETAILED DESCRIPTION OF ILLUSTRATIVE EMBODIMENT

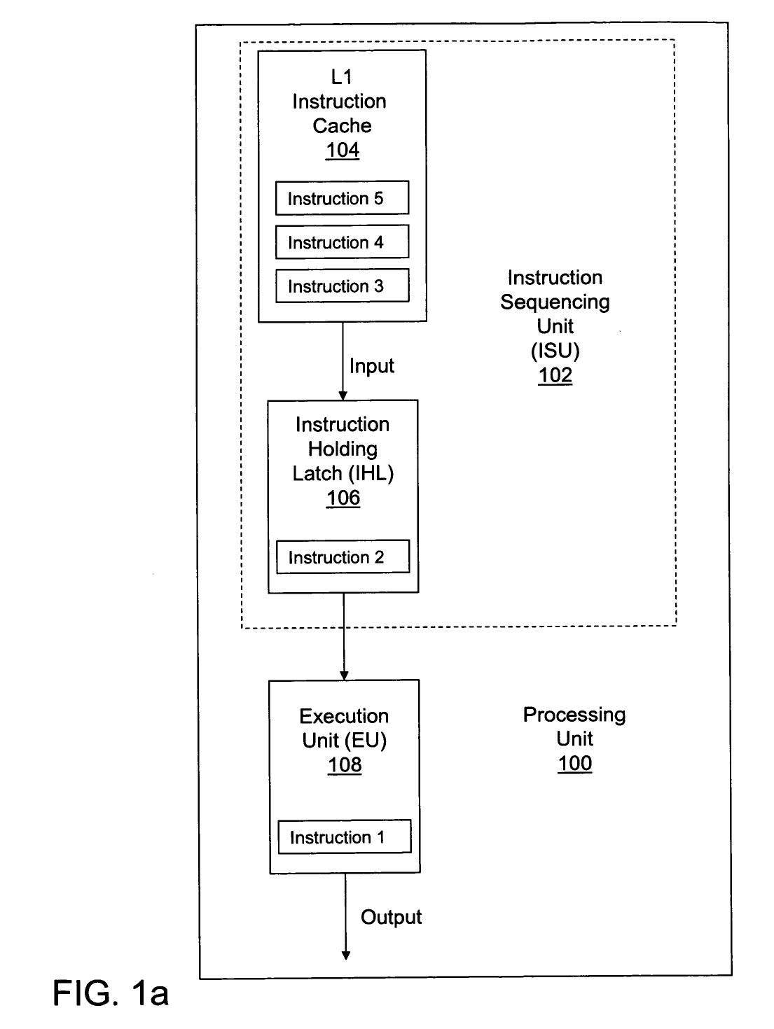

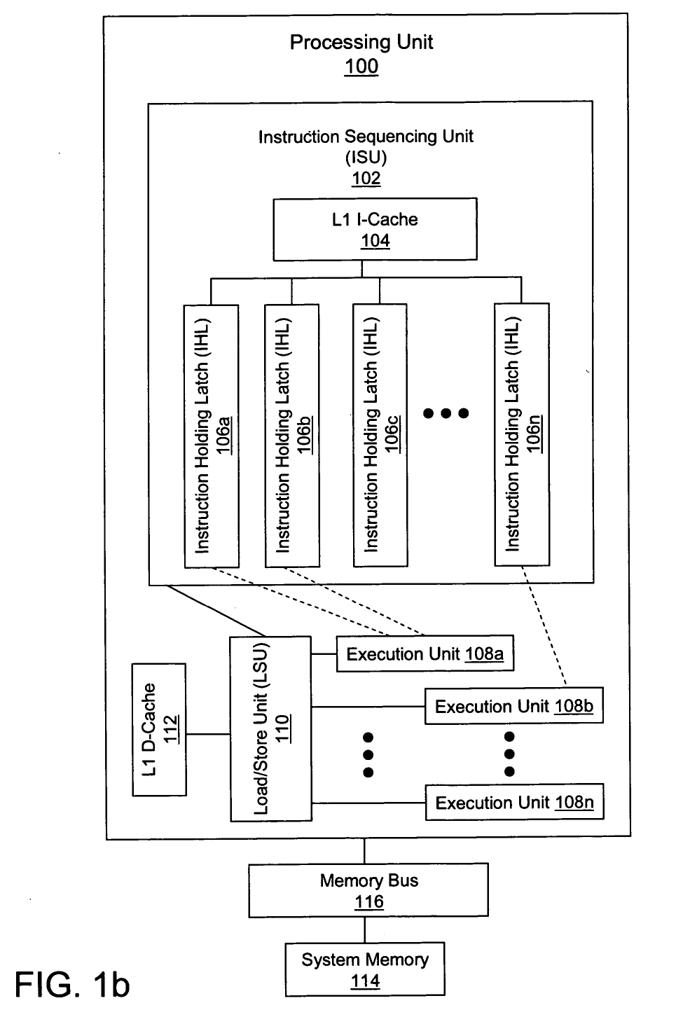

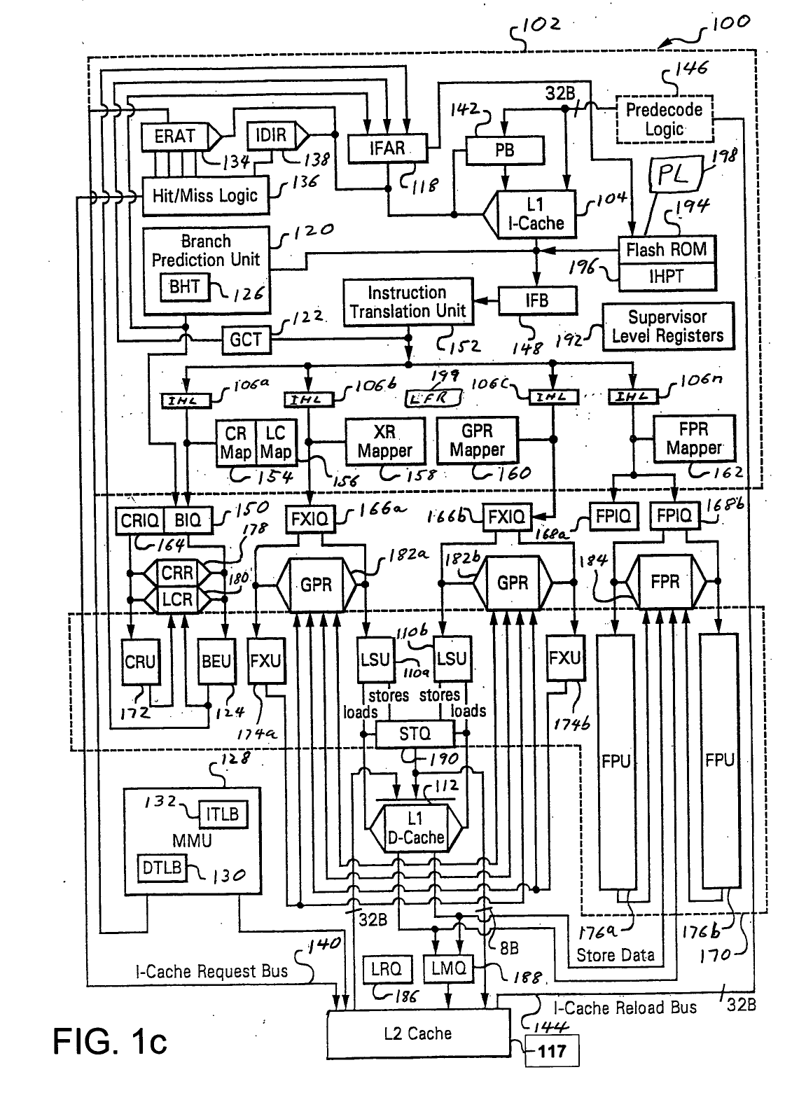

With reference now to the figures, FIG. 1a illustrates a portion of a conventional processing unit 100. Within the depicted portion of processing unit 100 is an Instruction Sequencing Unit (ISU) 102, which includes a Level-one (L1) Instruction Cache (I-Cache) 104 and an Instruction Holding Latch (IHL) 106. ISU 102 is coupled to an Execution Unit (EU) 108.

For purposes of illustration, assume that a process includes five instructions (i.e., operands) shown as Instructions 1-5. The process' first instruction, Instruction 1, has been loaded into EU 108, where it is being executed. The process' second instruction, Instruction 2, has been loaded into IHL 106, where it is waiting to be loaded into EU 108. The last three instructions, Instructions 3-5, are still being held in L1 I-Cache 104, from which they will eventually be sequentially loaded into IHL 106.

FIG. 1b provides additional detail of processing unit 100. As depicted, ISU 102 has multiple IHLs 106a-n. Each IHL 106 is able to store an instruction from threads from a same process or from different processes. In a preferred embodiment, each IHL 106 is dedicated to a specific one or more EUs 108. For example, IHL 106n may send instructions only to EU 108b, while IHLs 106a and 106b send instructions only to EU 108a.

Processing unit 100 also includes a Load/Store Unit (LSU) 110, which supplies instructions from ISU 102 and data (to be manipulated by instructions from ISU 102) from L1 Date Cache (D-Cache) 112. Both L1 I-Cache 104 and L1 D-Cache 112 are populated from a system memory 114, via a memory bus 116, in a computer system that supports and uses processing unit 100. Execution units 108 may include a floating point execution unit, a fixed point execution unit, a branch execution unit, etc.

Reference is now made to FIG. 1c, which shows additional detail for processing unit 100. Processing unit 100 includes an on-chip multi-level cache hierarchy including a unified level two (L2) cache 117 and bifurcated level one (L1) instruction (I) and data (D) caches 104 and 112, respectively. Caches 117, 104 and 112 provide low latency access to cache lines corresponding to memory locations in system memory 114.

Instructions are fetched for processing from L1 I-cache 104 in response to the effective address (EA) residing in an Instruction Fetch Address Register (IFAR) 118. During each cycle, a new instruction fetch address may be loaded into IFAR 118 from one of three sources: a Branch Prediction Unit (BPU) 120, which provides speculative target path and sequential addresses resulting from the prediction of conditional branch instructions; a Global Completion Table (GCT) 122, which provides flush and interrupt addresses; or a Branch Execution Unit (BEU) 124, which provides non-speculative addresses resulting from the resolution of predicted conditional branch instructions. Associated with BPU 120 is a Branch History Table (BHT) 126, in which are recorded the resolutions of conditional branch instructions to aid in the prediction of future branch instructions.

An Effective Address (EA), such as the instruction fetch address within IFAR 118, is the address of data or an instruction generated by a processor. The EA specifies a segment register and offset information within the segment. To access data (including instructions) in memory, the EA is converted to a Real Address (RA), through one or more levels of translation, associated with the physical location where the data or instructions are stored.

Within processing unit 100, effective-to-real address translation is performed by Memory Management Units (MMUs) and associated address translation facilities. Preferably, a separate MMU is provided for instruction accesses and data accesses. In FIG. 1c, a single MMU 128 is illustrated, for purposes of clarity, showing connections only to ISU 102. However, it should be understood that MMU 128 also preferably includes connections (not shown) to Load/Store Units (LSUs) 110a and 110b and other components necessary for managing memory accesses. MMU 128 includes Data Translation Lookaside Buffer (DTLB) 130 and instruction translation lookaside buffer (ITLB) 132. Each TLB contains recently referenced page table entries, which are accessed to translate EAs to RAs for data (DTLB 130) or instructions (ITLB 132). Recently referenced EA-to-RA translations from ITLB 132 are cached in an Effective-to-Real Address Table (ERAT) 134.

If hit/miss logic 136 determines, after translation of the EA contained in IFAR 118 by ERAT 134 and lookup of the Real Address (RA) in I-cache directory (IDIR) 138, that the cache line of instructions corresponding to the EA in IFAR 118 does not reside in L1 I-cache 104, then hit/miss logic 136 provides the RA to L2 cache 116 as a request address via I-cache request bus 140. Such request addresses may also be generated by prefetch logic within L2 cache 116 based upon recent access patterns. In response to a request address, L2 cache 116 outputs a cache line of instructions, which are loaded into Prefetch Buffer (PB) 142 and L1 I-cache 104 via I-cache reload bus 144, possibly after passing through optional predecode logic 146.

Once the cache line specified by the EA in IFAR 118 resides in L1 cache 104, L1 I-cache 104 outputs the cache line to both Branch Prediction Unit (BPU) 120 and to Instruction Fetch Buffer (IFB) 148. BPU 120 scans the cache line of instructions for branch instructions and predicts the outcome of conditional branch instructions, if any. Following a branch prediction, BPU 120 furnishes a speculative instruction fetch address to IFAR 118, as discussed above, and passes the prediction to branch instruction queue 150 so that the accuracy of the prediction can be determined when the conditional branch instruction is subsequently resolved by Branch Execution Unit (BEU) 124.

IFB 148 temporarily buffers the cache line of instructions received from L1 I-cache 104 until the cache line of instructions can be translated by Instruction Translation Unit (ITU) 152. In the illustrated embodiment of processing unit 100, ITU 152 translates instructions from User Instruction Set Architecture (UISA) instructions into a possibly different number of Internal ISA (IISA) instructions that are directly executable by the execution units of processing unit 100. Such translation may be performed, for example, by reference to microcode stored in a Read-Only Memory (ROM) template. In at least some embodiments, the UISA-to-IISA translation results in a different number of IISA instructions than UISA instructions and/or IISA instructions of different lengths than corresponding UISA instructions. The resultant IISA instructions are then assigned by Global Completion Table (GCT) 122 to an instruction group, the members of which are permitted to be dispatched and executed out-of-order with respect to one another. GCT 122 tracks each instruction group for which execution has yet to be completed by at least one associated EA, which is preferably the EA of the oldest instruction in the instruction group.

Following UISA-to-IISA instruction translation, instructions are dispatched to one of instruction holding latches 106a-n, possibly out-of-order, based upon instruction type. That is, branch instructions and other Condition Register (CR) modifying instructions are dispatched to instruction holding latch 106a, fixed-point and load-store instructions are dispatched to either of instruction holding latches 106b and 106c, and floating-point instructions are dispatched to instruction holding latch 106n. Each instruction requiring a rename register for temporarily storing execution results is then assigned one or more rename registers by the appropriate one of CR mapper 154, Link and Count (LC) register mapper 156, exception register (XR) mapper 158, General-Purpose Register (GPR) mapper 160, and Floating-Point Register (FPR) mapper 162.

The dispatched instructions are then temporarily placed in an appropriate one of CR Issue Queue (CRIQ) 164, Branch Issue Queue (BIQ) 150, Fixed-point Issue Queues (FXIQs) 166a and 166b, and Floating-Point Issue Queues (FPIQs) 168a and 168b. From issue queues 164, 150, 166a-b and 168a-b, instructions can be issued opportunistically to the execution units of processing unit 100 for execution as long as data dependencies and antidependencies are observed. The instructions, however, are maintained in issue queues 164, 150, 166a-b and 168a-b until execution of the instructions is complete and the result data, if any, are written back, in case any of the instructions needs to be reissued.

As illustrated, the execution units of processor core 170 include a CR Unit (CRU) 172 for executing CR-modifying instructions, Branch Execution Unit (BEU) 124 for executing branch instructions, two Fixed-point Units (FXUs) 174a and 174b for executing fixed-point instructions, two Load-Store Units (LSUs) 110a and 110b for executing load and store instructions, and two Floating-Point Units (FPUs) 176a and 176b for executing floating-point instructions. Each of execution units in processor core 170 is preferably implemented as an execution pipeline having a number of pipeline stages.

During execution within one of execution units in processor core 170, an instruction receives operands, if any, from one or more architected and/or rename registers within a register file coupled to the execution unit. When executing CR-modifying or CR-dependent instructions, CRU 172 and BEU 124 access the CR register file 178, which in a preferred embodiment contains a CR and a number of CR rename registers that each comprise a number of distinct fields formed of one or more bits. Among these fields are LT, GT, and EQ fields that respectively indicate if a value (typically the result or operand of an instruction) is less than zero, greater than zero, or equal to zero. Link and count register (LCR) register file 180 contains a Count Register (CTR), a Link Register (LR) and rename registers of each, by which BEU 124 may also resolve conditional branches to obtain a path address. General-Purpose Registers (GPRs) 182a and 182b, which are synchronized, duplicate register files, store fixed-point and integer values accessed and produced by FXUs 174a and 174b and LSUs 110a and 110b. Floating-point register file (FPR) 184, which like GPRs 182a and 182b may also be implemented as duplicate sets of synchronized registers, contains floating-point values that result from the execution of floating-point instructions by FPUs 176a and 176b and floating-point load instructions by LSUs 110a and 110b.

After an execution unit finishes execution of an instruction, the execution notifies GCT 122, which schedules completion of instructions in program order. To complete an instruction executed by one of CRU 172, FXUs 174a and 174b or FPUs 176a and 176b, GCT 122 signals the execution unit, which writes back the result data, if any, from the assigned rename register(s) to one or more architected registers within the appropriate register file. The instruction is then removed from the issue queue, and once all instructions within its instruction group have completed, is removed from GCT 122. Other types of instructions, however, are completed differently.

When BEU 124 resolves a conditional branch instruction and determines the path address of the execution path that should be taken, the path address is compared against the speculative path address predicted by BPU 120. If the path addresses match, no further processing is required. If, however, the calculated path address does not match the predicted path address, BEU 124 supplies the correct path address to IFAR 118. In either event, the branch instruction can then be removed from BIQ 150, and when all other instructions within the same instruction group have completed, from GCT 122.

Following execution of a load instruction, the effective address computed by executing the load instruction is translated to a real address by a data ERAT (not illustrated) and then provided to L1 D-cache 112 as a request address. At this point, the load instruction is removed from FXIQ 166a or 166b and placed in Load Reorder Queue (LRQ) 186 until the indicated load is performed. If the request address misses in L1 D-cache 112, the request address is placed in Load Miss Queue (LMQ) 188, from which the requested data is retrieved from L2 cache 116, and failing that, from another processing unit 100 or from system memory 114 (shown in FIG. 1b). LRQ 186 snoops exclusive access requests (e.g., read-with-intent-to-modify), flushes or kills on an interconnect fabric against loads in flight, and if a hit occurs, cancels and reissues the load instruction. Store instructions are similarly completed utilizing a Store Queue (STQ) 190 into which effective addresses for stores are loaded following execution of the store instructions. From STQ 190, data can be stored into either or both of L1 D-cache 112 and L2 cache 116.

Processing unit 100 also includes a Latch Freezing Register (LFR) 199. LFR 199 contains masked bits, as will be describe in additional detail below, that control whether a specific IHL 106 is able to receive a clock signal. If a clock signal to a specific IHL 106 is temporarily blocked, then that IHL 106, as well as the instruction/thread that is using that IHL and its attendant execution units, is temporarily frozen.

Processor States

The state of a processor includes stored data, instructions and hardware states at a particular time, and is herein defined as either being “hard” or “soft.” The “hard” state is defined as the information within a processor that is architecturally required for a processor to execute a process from its present point in the process. The “soft” state, by contrast, is defined as information within a processor that would improve efficiency of execution of a process, but is not required to achieve an architecturally correct result. In processing unit 100 of FIG. 1c, the hard state includes the contents of user-level registers, such as CRR 178, LCR 180, GPRs 182a-b, FPR 184, as well as supervisor level registers 192. The soft state of processing unit 100 includes both “performance-critical” information, such as the contents of L-1 I-cache 104, L-1 D-cache 112, address translation information such as DTLB 130 and ITLB 132, and less critical information, such as BHT 126 and all or part of the content of L2 cache 116.

In one embodiment, the hard and soft states are stored (moved to) registers as described herein. However, in a preferred embodiment, the hard and soft states simply “remain in place,” since the hardware processing a frozen instruction (and thread) is suspended (frozen), such that the hard and soft states likewise remain frozen until the attendant hardware is unfrozen.

Interrupt Handlers

First Level Interrupt Handlers (FLIHs) and Second Level Interrupt Handlers (SLIHs) may be stored in system memory, and populate the cache memory hierarchy when called. However, calling a FLIH or SLIH from system memory may result in a long access latency (to locate and load the FLIH/SLIH from system memory after a cache miss). Similarly, populating cache memory with FLIH/SLIH instructions and data “pollutes” the cache with data and instructions that are not needed by subsequent processes.

To reduce the access latency of FLIHs and SLIHs and to avoid cache pollution, in a preferred embodiment processing unit 100 stores at least some FLIHs and SLIHs in a special on-chip memory (e.g., flash Read Only Memory (ROM) 194). FLIHs and SLIHs may be burned into flash ROM 194 at the time of manufacture, or may be burned in after manufacture by flash programming. When an interrupt is received by processing unit 100, the FLIH/SLIH is directly accessed from flash ROM 194 rather than from system memory 114 or a cache hierarchy that includes L2 cache 116.

SLIH Prediction

Normally, when an interrupt occurs in processing unit 100, a FLIH is called, which then calls a SLIH, which completes the handling of the interrupt. Which SLIH is called and how that SLIH executes varies, and is dependent on a variety of factors including parameters passed, conditions states, etc. Because program behavior can be repetitive, it is frequently the case that an interrupt will occur multiple times, resulting in the execution of the same FLIH and SLIH. Consequently, the present invention recognizes that interrupt handling for subsequent occurrences of an interrupt may be accelerated by predicting that the control graph of the interrupt handling process will be repeated and by speculatively executing portions of the SLIH without first executing the FLIH.

To facilitate interrupt handling prediction, processing unit 100 is equipped with an Interrupt Handler Prediction Table (IHPT) 196. IHPT 196 contains a list of the base addresses (interrupt vectors) of multiple FLIHs. In association with each FLIH address, IHPT 196 stores a respective set of one or more SLIH addresses that have previously been called by the associated FLIH. When IHPT 196 is accessed with the base address for a specific FLIH, a Prediction Logic (PL) 198 selects a SLIH address associated with the specified FLIH address in IHPT 196 as the address of the SLIH that will likely be called by the specified FLIH. Note that while the predicted SLIH address illustrated may be the base address of a SLIH, the address may also be an address of an instruction within the SLIH subsequent to the starting point (e.g., at point B).

Prediction logic (PL) 198 uses an algorithm that predicts which SLIH will be called by the specified FLIH. In a preferred embodiment, this algorithm picks a SLIH, associated with the specified FLIH, that has been used most recently. In another preferred embodiment, this algorithm picks a SLIH, associated with the specified FLIH, that has historically been called most frequently. In either described preferred embodiment, the algorithm may be run upon a request for the predicted SLIH, or the predicted SLIH may be continuously updated and stored in IHPT 196.

It is to be noted that the present invention is different from branch prediction methods known in the art. First, the method described above results in a jump to a specific interrupt handler, and is not based on a branch instruction address. That is, branch prediction methods used in the prior art predict the outcome of a branch operation, while the present invention predicts a jump to a specific interrupt handler based on a (possibly) non-branch instruction. This leads to a second difference, which is that a greater amount of code can be skipped by interrupt handler prediction as taught by the present invention as compared to prior art branch prediction, because the present invention allows bypassing any number of instructions (such as in the FLIH), while a branch prediction permits bypassing only a limited number of instructions before the predicted branch due to inherent limitations in the size of the instruction window that can be scanned by a conventional branch prediction mechanism. Third, interrupt handler prediction in accordance with the present invention is not constrained to a binary determination as are the taken/not taken branch predictions known in the prior art. Thus, referring again to FIG. 1c, prediction logic 198 may choose predicted SLIH address from any number of historical SLIH addresses, while a branch prediction scheme chooses among only a sequential execution path and a branch path.

Registers

In the description above, register files of processing unit 100 such as GPRs 182a-b, FPR 184, CRR 178 and LCR 180 are generally defined as “user-level registers,” in that these registers can be accessed by all software with either user or supervisor privileges. Supervisor level registers 192 include those registers that are used typically by an operating system, typically in the operating system kernel, for such operations as memory management, configuration and exception handling. As such, access to supervisor level registers 192 is generally restricted to only a few processes with sufficient access permission (i.e., supervisor level processes).

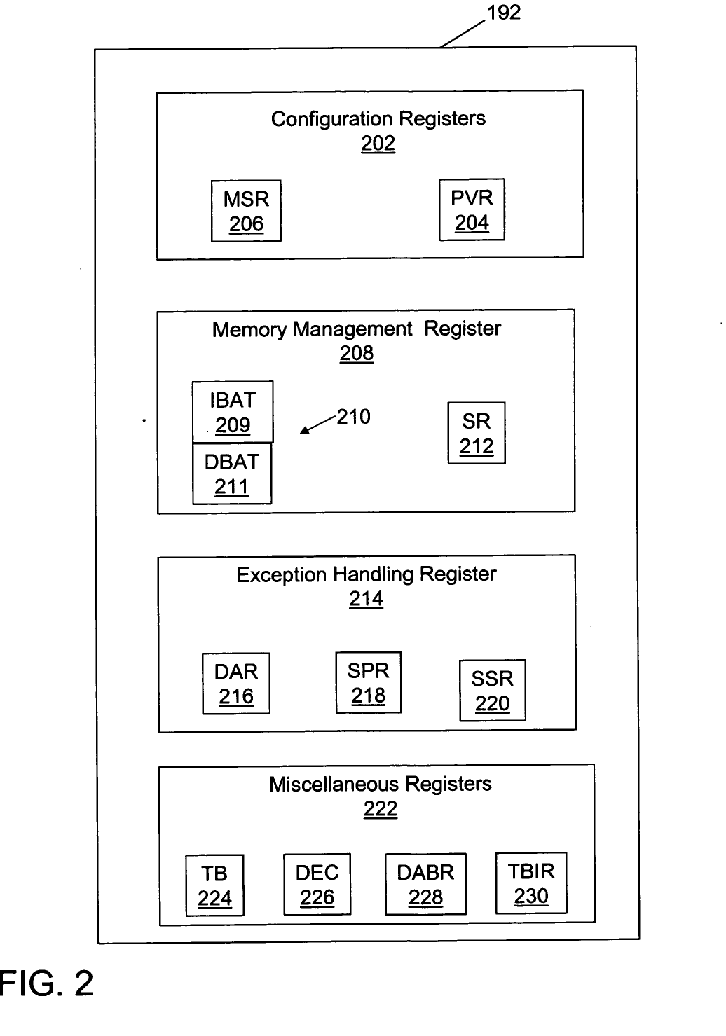

As depicted in FIG. 2, supervisor level registers 192 generally include configuration registers 202, memory management registers 208, exception handling registers 214, and miscellaneous registers 222, which are described in more detail below.

Configuration registers 202 include a Machine State Register (MSR) 206 and a Processor Version Register (PVR) 204. MSR 206 defines the state of the processor. That is, MSR 206 identifies where instruction execution should resume after an instruction interrupt (exception) is handled. PVR 204 identifies the specific type (version) of processing unit 100.

Memory management registers 208 include Block-Address Translation (BAT) registers 210. BAT registers 210 are software-controlled arrays that store available block-address translations on-chip. Preferably, there are separate instruction and data BAT registers, shown as IBAT 209 and DBAT 211. Memory management registers also include Segment Registers (SR) 212, which are used to translate EAs to Virtual Addresses (VAs) when BAT translation fails

Exception handling registers 214 include a Data Address Register (DAR) 216, Special Purpose Registers (SPRs) 218, and machine Status Save/Restore (SSR) registers 220. The DAR 216 contains the effective address generated by a memory access instruction if the access causes an exception, such as an alignment exception. SPRs are used for special purposes defined by the operating system, for example, to identify an area of memory reserved for use by a first-level exception handler (e.g., a FLIH). This memory area is preferably unique for each processor in the system. An SPR 218 may be used as a scratch register by the FLIH to save the content of a General Purpose Register (GPR), which can be loaded from SPR 218 and used as a base register to save other GPRs to memory. SSR registers 220 save machine status on exceptions (interrupts) and restore machine status when a return from interrupt instruction is executed.

Miscellaneous registers 222 include a Time Base (TB) register 224 for maintaining the time of day, a Decrementer Register (DEC) 226 for decrementing counting, and a Data Address Breakpoint Register (DABR) 228 to cause a breakpoint to occur if a specified data address is encountered. Further, miscellaneous registers 222 include a Time Based Interrupt Register (TBIR) 230 to initiate an interrupt after a pre-determined period of time. Such time based interrupts may be used with periodic maintenance routines to be run on processing unit 100.

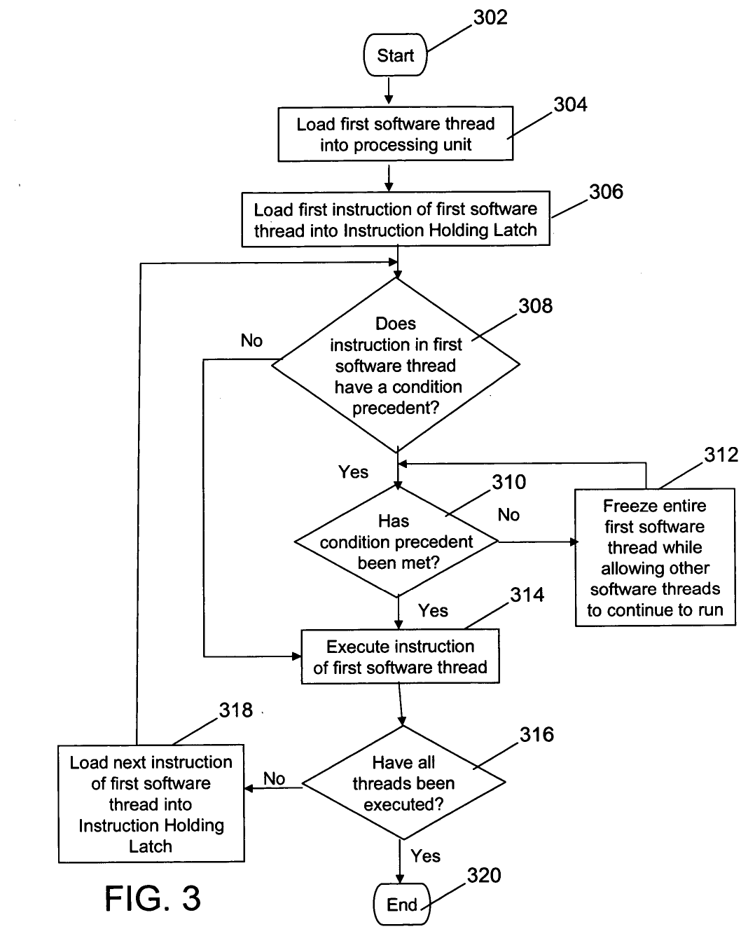

Referring now to FIG. 3, there is depicted a flowchart of an exemplary method by which a processing unit, such as processing unit 100, handles an interrupt, pause, exception, or other disturbance of an execution of instructions in a software thread. After initiator block 302, a first software thread is loaded (block 304) into a processing unit, such as processing unit 100 shown and described above. Specifically, instructions in the software thread are pipelined in under the control of IFAR 118 and other components described above. The first instruction in that first software thread is then loaded (block 306) into an appropriate Instruction Holding Latch (IHL). An appropriate IHL is preferably one that is dedicated to an Execution Unit specifically designed to handle the type of instruction being loaded.

A query (query block 308) is then made as to whether the loaded instruction has a condition precedent, such as a need for a specific piece of data (such as data produced by another instruction), a passage of a pre-determined number of clock cycles, or any other condition, including those represented in the registers depicted in FIG. 2, before that instruction may be executed.

If the condition precedent has not been met (query block 310), then the IHL holding the instruction is frozen (block 312), thus freezing the entire first software thread. Note, however, that other software threads and other EUs 108 are still able to continue to execute. For example, assume that IHL 106n shown in FIG. 1b is frozen. If so, then EU 108b is unable to be used, but all other EUs 108 can still be used by other unfrozen IHLs 106.

If the condition precedent has been met (query block 310), then the instruction is executed in the appropriate execution unit (block 314).

A query is then made as to whether there are other instructions to be executed in the software thread (query block 316). If not, the process ends (terminator block 320). Otherwise, the next instruction is loaded into an Instruction Holding Latch (block 318), and the process re-iterates as shown until all instructions in the thread have been executed.

As noted above, in a preferred embodiment no soft or hard states need to be stored, since the entire software thread and the hardware associated with that software thread's execution are simply frozen until a signal is received unfreezing a specific IHL 106. Alternatively, soft and/or hard states may be stored in a GPR 182, IFAR 118, or any other storage register, preferably one that is on (local to) processing unit 100.

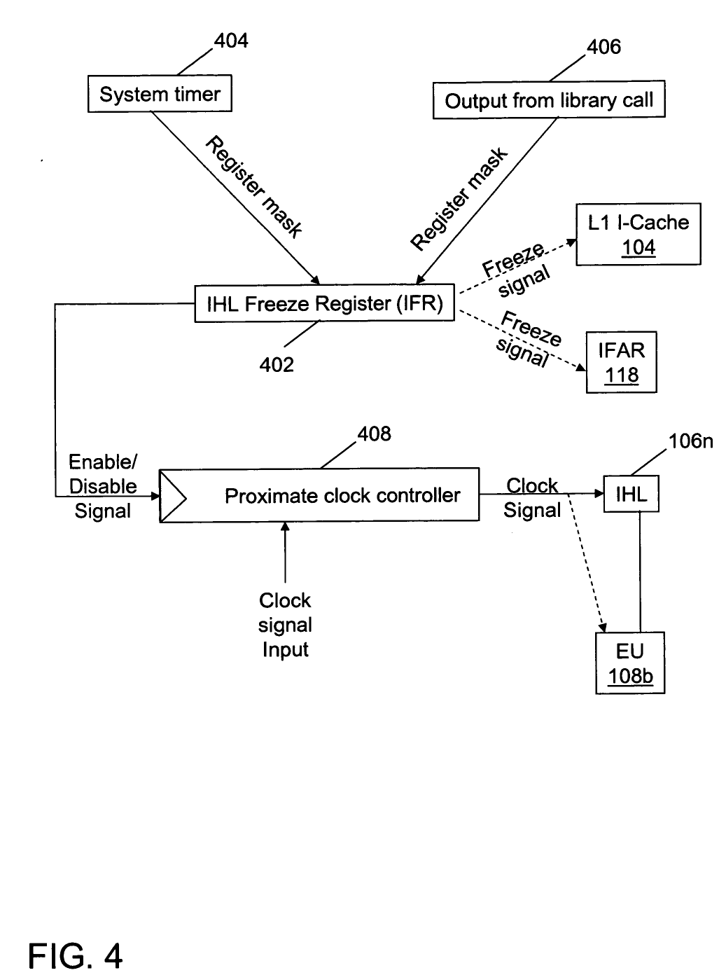

A preferred system for freezing an Instruction Holding Latch (IHL) 106 is shown in FIG. 4. An IHL 106n, shown initially in FIG. 1b and used in FIG. 4 for exemplary purposes, is coupled to a single Execution Unit (EU) 108b. The functionality of IHL 106n is dependent on a clock signal, which is required for normal operation of IHL 106n. Without a clock signal, IHL 106n will simply “freeze,” resulting in L1 I-cache 104 (shown in FIG. 1b) being prevented from being able to send any new instructions to IHL 106n that are from the same software thread as the instruction that is frozen in IHL 106n. Alternatively, the instruction to freeze the entire upstream portion of the software thread may be accomplished by sending a freeze signal to IFAR 118.

The operation of EU 108b may continue, resulting in the execution of any instruction that is in the same thread as the instruction that is frozen in IHL 106n. In another embodiment, however, EU 108b is also frozen when IHL 106n is frozen, preferably by controlling the clock signal to EU 108b as shown.

Control of the clock signal is accomplished by masking IHL Freeze Register (IFR) 402. IFR 402 contains a control bit for every IHL 106 (and optionally every EU 108, L1 I-Cache 104, and IFAR 118). This mask can be created by various sources. For example, a system timer 404 may create a mask indicating if a pre-determined amount of time has elapsed. In a preferred embodiment, an output from a library call 406 controls to loading (masking) of IFR 402.

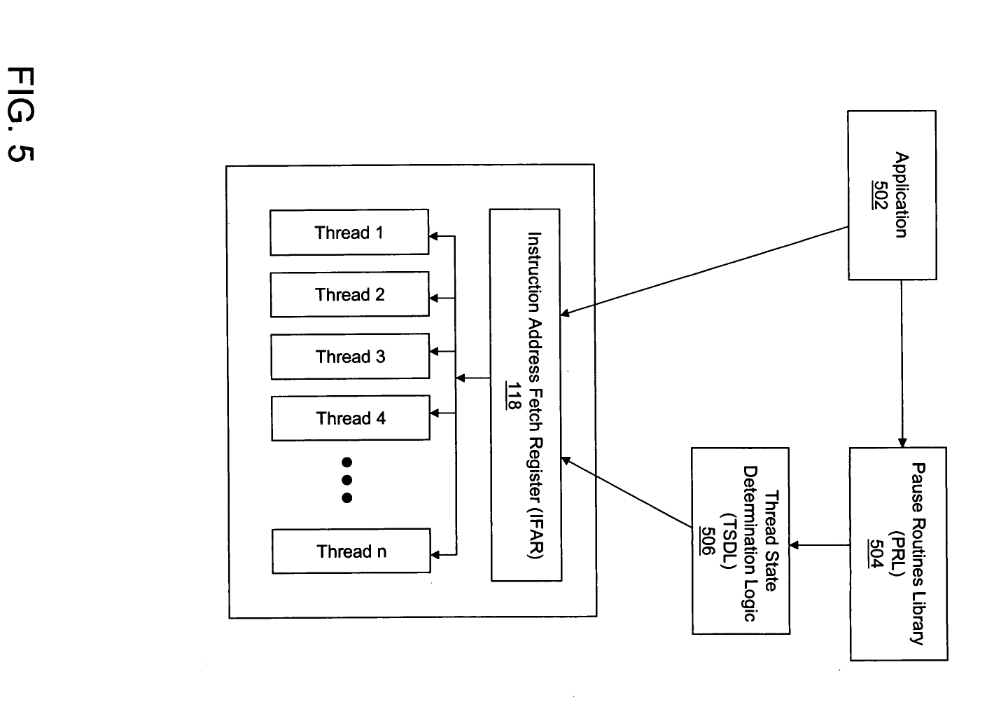

As described in FIG. 5, an application (or process or thread) may make a call to a library when a particular condition occurs (such as required execution data being unavailable). The library call results in logic execution that determine if the running software thread needs to be paused (frozen). If so, then a disable signal is sent to a Proximate Clock Controller (PCC) 408, (shown in FIG. 4) resulting in a clock signal being blocked to IHL 106n (and optionally EU 108b). A freeze signal can also be sent to L1 I-Cache 104 and/or IFAR 118. This freeze signal may be a singular signal (such as a clock signal blocker to L1 I-Cache 104), or it may result in executable code to IFAR 118 that causes IFAR 118 to select out the particular software thread that is to be frozen.

Once the condition precedent has been met for execution of the frozen instruction, then IFR 402 issues an “enable” command to PCC 408, and optionally an “unfreeze” signal to L1 I-Cache 104 and/or IFAR 118, permitting the instruction and the rest of the instructions in its thread to execute through the IHLs 106 and EUs 108 for that thread.

With reference again to FIG. 5, application 502 normally works directly with IFAR 118, which calls each instruction in a software thread. When an anomaly occurs, such as needed data not being available, a call is made to a Pause Routines Library (PRL) 504. PRL 504 executes a called file, which is executed by a Thread State Determination Logic (TSDL) 506. TSDL 506 then controls IFAR 118 (or alternatively PCC 408 shown in FIG. 4) to freeze a specific software thread under the control of IFAR 118.

Although aspects of the present invention have been described with respect to a computer processor and software, it should be understood that at least some aspects of the present invention may alternatively be implemented as a computer-usable medium that contains program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. a floppy diskette, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method of pausing a software thread, the method comprising:
sending an instruction from a first software thread to an Instruction Sequencing Unit (ISU) in a processing unit;
sending the instruction from the first software thread to a first instruction holding latch, the first instruction holding latch being from a plurality of instruction holding latches in the ISU; and
selectively freezing the first instruction holding latch, wherein the instruction from the first software thread is unable to pass to an execution unit in a processor core while the first instruction holding latch is frozen, and wherein execution of the first software thread is frozen.

2. The method of claim 1, wherein the selective freezing of the first instruction holding latch is controlled by a wait register, and wherein the wait register contains a control bit for controlling a freeze state of each of the plurality of instruction holding latches.

3. The method of claim 2, wherein the wait register is masked with values defined by a hardware clock counter.

4. The method of claim 2, wherein the wait register is masked with values defined by a routine called from a library.

5. The method of claim 1, wherein the first instruction holding latch is frozen by blocking a clock signal to the first instruction holding latch.

6. The method of claim 6, wherein the clock signal to the first instruction holding latch is a clock output signal from a clock controller, and wherein the clock output signal from the clock controller is controlled by a control bit in a wait register.

7. The method of claim 1, wherein the first instruction holding latch is dedicated to a single execution unit in the processor core.

8. The method of claim 1, further comprising:
determining that a condition that prompted selectively freezing the first instruction holding latch has ended, such that the first software thread is now able to pass to the execution unit in the processor core.

9. The method of claim 8, wherein an incomplete execution of another software thread is the condition that prompted selectively freezing the first instruction holding latch.

10. The method of claim 8, wherein an incomplete passage of a predetermined number of clock cycles is the condition that prompted selectively freezing the first instruction holding latch.

11. The method of claim 8, wherein a lack of requisite data to be used by the first software thread is the condition that prompted selectively freezing the first instruction holding latch.

12. A system comprising:
means for sending a first software thread to a processing unit, wherein the first software thread is from a plurality of software threads capable of being simultaneously executed by a processor core having multiple execution units; and
means for, in response to a specified condition occurring, pausing the first software thread without pausing any other software threads in the plurality of software threads and without invoking a call to an operating system.

13. The system of claim 12, wherein the first software thread is paused until another thread in the plurality of software threads executes.

14. The system of claim 12, wherein the first software thread is paused until a pre-determined amount of time transpires.

15. A computer-usable medium embodying computer program code, the computer program code comprising computer executable instructions configured to:
send a first software thread to a processing unit; wherein the first software thread is from a plurality of software threads capable of being simultaneously executed by a processor core having multiple execution units; and
responsive to a specified condition occurring, pause the first software thread without pausing any other software threads in the plurality of software threads and without invoking a call to an operating system.

16. The computer-usable medium of claim 15, wherein the first software thread is paused until another thread in the plurality of software threads executes.

17. The computer-usable medium of claim 15, wherein the first software thread is paused until a pre-determined amount of time transpires.
